(19) United States
(12) Patent Application Publication
(10) Pub. No.: US 2017/0097751 A1
(43) Pub. Date: Apr. 6, 2017

(54) ELECTRONIC DEVICE FOR PROVIDING ONE-HANDED USER INTERFACE AND METHOD THEREFOR

(71) Applicant: Samsung Electronics Co., Ltd, Gyeonggi-do (KR)

(72) Inventors: Yoon Ho Lee, Incheon (KR); Kyung Seok Lee, Gyeonggi-do (KR)

(21) Appl. No.: 15/286,513

(22) Filed: Oct. 5, 2016

(30) Foreign Application Priority Data
Oct. 5, 2015 (KR) 10-2015-0140029

(51) Int. Cl. G06F 3/0486; G06F 3/0481; G06F 3/0488

(52) U.S. Cl. CPC G06F 3/0486; G06F 3/04883; G06F 3/04812; G06F 2203/04803

(57) ABSTRACT

An embodiment provides an electronic device. The electronic device includes a display module configured to display at least one content, a touch screen module configured to detect a touch input, a memory configured to store an unlock solution, and a processor electrically connected to the touch screen module, the display module, and the memory. The processor displays an unlock user interface (UI) through the display module. The processor also receives a touch input, for inputting an unlock solution on the unlock UI, through the touch screen module. The processor also displays a short-cut UI, including a plurality of icons, on the unlock UI through the display module in response to a position where the input unlock resolution is ended.

### CROSS-REFERENCE TO RELATED APPLICATION(S) AND CLAIM OF PRIORITY

The present application is related to and claims the benefit under 35 U.S.C. §119(a) of a Korean patent application filed on Oct. 5, 2015 in the Korean Intellectual Property Office and assigned Serial number 10-2015-0140029, the entire disclosure of which is hereby incorporated by reference.

### TECHNICAL FIELD

The present disclosure relates to electronic devices for providing one-handed interfaces (UIs) and methods therefor.

### BACKGROUND

With the development of information and communication technologies, network devices, such as base stations, have been installed in all parts of the country. Electronic devices communicate data with other electronic devices over networks such that users may freely use networks throughout the country.

Various types of electronic devices may provide a variety of functions depending on recent trends in digital convergence. For example, a smartphone supports an Internet access function using a network, supports a music or video play function using the Internet, and supports a photo or video capturing function using an image sensor, other than a call function.

In addition, various user interface (UI) technologies have been developed as methods for effectively providing the above-mentioned convenient functions to users in the electronic device. There may be a graphic user interface (GUI) displayed on a screen of the electronic device as the best example.

### SUMMARY

To address the above-discussed deficiencies, it is a primary object to provide an electronic device for providing a user interface (UI) for easily performing a one-handed operation of the electronic device having a relatively larger display and a method therefor.

An embodiment of the present disclosure provides an electronic device. The electronic device may include a display circuit configured to display a control object and a content icon spaced from the control object on a screen of the electronic device. The electronic device also includes a user input circuit configured to receive a user input. The electronic device also includes a processor configured to electrically connect with the display circuit and the user input circuit. The processor is configured to execute content corresponding to the content icon in response to receiving a series of user inputs including touch-down, touch drag, and touch release associated with the control object.

Another embodiment of the present disclosure provides a method performed in an electronic device. The method may include displaying a control object and a content icon spaced from the control object on a screen of the electronic device. The method may also include receiving a series of user inputs including touch-down, touch drag, and touch release associated with the control object. The method may also include executing content corresponding to the content icon in response to the received user inputs.

Other aspects and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a configuration of an electronic device in a network environment according to various embodiments of the present disclosure;

FIG. 2 illustrates a block diagram of a configuration of an electronic device according to various embodiments of the present disclosure;

FIG. 3 illustrates a block diagram of a configuration of a program module according to various embodiments of the present disclosure;

FIG. 4 illustrates a block diagram of a configuration of an electronic device for providing a one-handed UI according to various embodiments of the present disclosure;

FIG. 5 illustrates a drawing of a basic state of a one-handed UI according to various embodiments of the present disclosure;

FIG. 6 illustrates a drawing of a one-handed UI of a state where a touch-down user input on a control object is received according to various embodiments of the present disclosure;

FIG. 7 illustrates a drawing of a one-handed UI of a state where a touch drag user input on a control object is received according to various embodiments of the present disclosure;

FIG. 8 illustrates a drawing of a one-handed UI of a state where a touch release user input on a control object is received according to various embodiments of the present disclosure;

FIG. 9 illustrates a drawing of a one-handed UI of a state where a touch drag user input on a control object is received according to various embodiments of the present disclosure;

FIG. 10 illustrates a drawing of a one-handed UI of a state where a control object is adjacent to a function object according to various embodiments of the present disclosure;

FIG. 11A illustrates a drawing of a one-handed UI of a state where a control object is adjacent to a function object according to various embodiments of the present disclosure;

FIG. 11B illustrates a drawing of a one-handed UI of a state where a function object is activated based a location of a control object according to various embodiments of the present disclosure;

FIG. 11C illustrates a drawing of a one-handed UI where an operation for a function object is executed according to various embodiments of the present disclosure;

FIG. 12 illustrates a drawing of a one-handed UI of a state where a point is adjacent to a function object according to various embodiments of the present disclosure;

FIG. 13 illustrates a drawing of a one-handed UI of a state where a right-handed mode and a left-handed mode are converted into each other according to various embodiments of the present disclosure;

FIG. 14 illustrates a drawing of a one-handed UI of a state where a touch-down user input on a control object is received according to various embodiments of the present disclosure;

FIG. 15A illustrates a drawing of a one-handed UI for a transverse mode of an electronic device according to various embodiments of the present disclosure;

FIG. 15B illustrates a drawing of a one-handed UI for a transverse mode of an electronic device according to various embodiments of the present disclosure;

FIG. 15C illustrates a drawing of a one-handed UI for a transverse mode of an electronic device according to various embodiments of the present disclosure;

FIG. 15D illustrates a drawing of a one-handed UI for a transverse mode of an electronic device according to various embodiments of the present disclosure;

FIG. 15E illustrates a drawing of a one-handed UI for a transverse mode of an electronic device according to various embodiments of the present disclosure;

FIG. 15F illustrates a drawing of a one-handed UI for a transverse mode of an electronic device according to various embodiments of the present disclosure;

FIG. 16A illustrates a drawing of a one-handed UI of a state where a touch hold user input on a control object is received according to various embodiments of the present disclosure;

FIG. 16B illustrates a drawing of a one-handed UI of a state where a touch hold user input on a control object is received according to various embodiments of the present disclosure;

FIG. 17A illustrates a drawing of a location where a control object is displayed again upon touch release on a control object on a one-handed UI according to various embodiments of the present disclosure;

FIG. 17B illustrates a drawing of a location where a control object is displayed again upon touch release on a control object on a one-handed UI according to various embodiments of the present disclosure;

FIG. 18 illustrates a process performed on a one-handed UI according to various embodiments of the present disclosure; and

FIG. 19 illustrates a process performed on a one-handed UI according to various embodiments of the present disclosure.

Throughout the drawings, it should be noted that like reference numbers are used to depict the same or similar elements, features, and structures.

### DETAILED DESCRIPTION

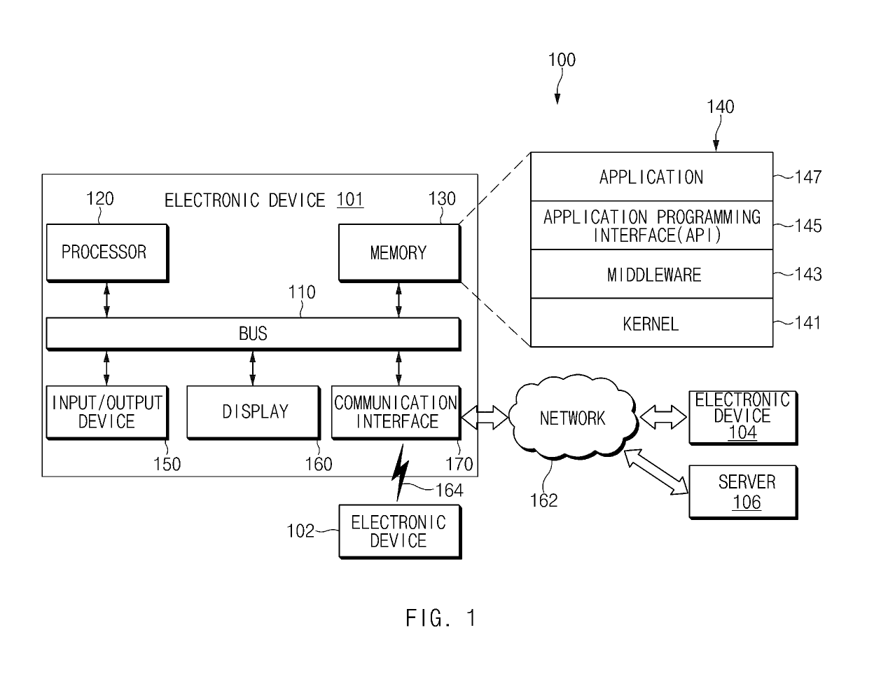

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device or method.

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments, but do not limit the elements. Furthermore, such terms may be used to distinguish one element from another element. For example, “a first user device” and “a second user device” may indicate different user devices regardless of the order or priority thereof. For example, “a first user device” and “a second user device” indicate different user devices.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in the present disclosure are used to describe specified embodiments and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some examples, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, e-book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to another embodiment, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync®, Apple TV®, or Google TV®), game consoles (e.g., Xbox® or PlayStation®), electronic dictionaries, electronic keys, camcorders, electronic picture frames, or the like.

According to another embodiment, the photographing apparatus may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). In the various embodiments, the electronic device may be one of the above-described various devices or a combination thereof. An electronic device according to an embodiment may be a flexible device. Furthermore, an electronic device according to an embodiment may not be limited to the above-described electronic devices and may include other electronic devices and new electronic devices according to the development of technologies.

Hereinafter, an electronic device according to the various embodiments may be described with reference to the accompanying drawings. The term “user” used herein may refer to a person who uses an electronic device or may refer to a device (e.g., an artificial intelligence electronic device) that uses an electronic device.

FIG. 1 illustrates a block diagram of a configuration of an electronic device 100 in a network environment according to various embodiments of the present disclosure. A description will be given of the electronic device 100 in the network environment with reference to FIG. 1 in various embodiments. The electronic device 100 may include a bus 110, a processor 120, a memory 130, an input/output (I/O) interface 150, a display circuit 160 (or display), and a communication circuit 170 (or communication interface). In various embodiments, at least one of the components may be omitted from the electronic device 100, or another component may be additionally included in the electronic device 100.

The bus 110 may be, for example, a circuit which connects the components 120 to 170 with each other and transmits communication (e.g., a control message and/or data) between the components.

The processor 120 may include one or more of a central processing unit (CPU), an application processor (AP), or a communication processor (CP). For example, the processor 120 may perform calculation or data processing about control and/or communication of at least another of the components of the electronic device 100.

The memory 130 may include a volatile and/or non-volatile memory. The memory 130 may store, for example, instructions or data associated with at least another of the components of the electronic device 100. According to an embodiment, the memory 130 may software and/or a program 140. The program 140 may include, for example, a kernel 141, a middleware 143, an application programming interface (API) 145, and/or at least one application program 147 (or an “at least one application”), and the like. At least part of the kernel 141, the middleware 143, or the API 145 may be referred to as an operating system (OS).

The kernel 141 may control or manage, for example, system resources (e.g., the bus 110, the processor 120, or the memory 130, and the like) used to execute an operation or function implemented in the other programs (e.g., the middleware 143, the API 145, or the application program 147). Also, as the middleware 143, the API 145, or the application program 147 accesses a separate component of the electronic device 100, the kernel 141 may provide an interface which may control or manage system resources.

The middleware 143 may play a role as, for example, a go-between such that the API 145 or the application program 147 communicates with the kernel 141 to communicate data.

Also, the middleware 143 may process one or more work requests, received from the application program 147, in order of priority. For example, the middleware 143 may assign priority which may use system resources (the bus 110, the processor 120, or the memory 130, and the like) of the electronic device 100 to at least one of the at least one application program 147. For example, the middleware 143 may perform scheduling or load balancing for the one or more work requests by processing the one or more work requests in order of priority assigned to the at least one of the at least one application program 147.

The API 145 may be, for example, an interface in which the application program 147 controls a function provided from the kernel 141 or the middleware 143. For example, the API 145 may include at least one interface or function (e.g., instruction) for file control, window control, image processing, or text control, and the like.

The I/O interface 150 may play a role as, for example, an interface which may transmit instructions or data, input from a user or another external device, to another component (or other components) of the electronic device 100. Also, the I/O interface 150 may output instructions or data, received from another component (or other components) of the electronic device 100, to the user or the other external device.

The display circuit 160 may include, for example, a liquid crystal display (LCD), a light emitting diode (LED) display, an organic LED (OLED) display, a microelectromechanical systems (MEMS) display, or an electronic paper display. The display circuit 160 may display, for example, a variety of content (e.g., text, an image, a video, an icon, or a symbol, and the like) to the user. The display circuit 160 may include a touch screen, and may receive, for example, a touch, a gesture, proximity, or a hovering input using an electronic pen or part of a body of the user.

The communication circuit 170 may establish communication between, for example, the electronic device 100 and an external device (e.g., a first external electronic device 102, a second external electronic device 104, or a server 106). For example, the communication circuit 170 may connect to a network 162 through wireless communication or wired communication and may communicate with the external device (e.g., the second external electronic device 104 or the server 106).

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Also, the wireless communication may include, for example, local-area communication 164. The local-area communication 164 may include, for example, at least one of wireless-fidelity (Wi-Fi) communication, Bluetooth (BT) communication, near field communication (NFC), or global navigation satellite system (GNSS) communication, and the like. The GNSS may include, for example, at least one of a global positioning system (GPS), a Glonass, a Beidou navigation satellite system (hereinafter referred to as “Beidou”), or a Galileo (i.e., the European global satellite-based navigation system) according to an available area or a bandwidth, and the like. Hereinafter, the “GPS” used herein may be interchangeably with the “GNSS”. The wired communication may include at least one of, for example, universal serial bus (USB) communication, high definition multimedia interface (HDMI) communication, recommended standard 232 (RS-232) communication, or plain old telephone service (POTS) communication, and the like. The network 162 may include a telecommunications network, for example, at least one of a computer network (e.g., a local area network (LAN) or a wide area network (WAN)), the Internet, or a telephone network.

Each of the first and second external electronic devices 102 and 104 may be the same as or different device from the electronic device 100. According to an embodiment, the server 106 may include a group of one or more servers. According to various embodiments, all or some of operations executed in the electronic device 100 may be executed in another electronic device or a plurality of electronic devices (e.g., the first external electronic device 102, the second external electronic device 104, or the server 106). According to an embodiment, if the electronic device 100 should perform any function or service automatically or according to a request, it may request another device (e.g., the first external electronic device 102, the second external electronic device 104, or the server 106) to perform at least part of the function or service, rather than executing the function or service for itself or in addition to the function or service. The other electronic device (e.g., the first external electronic device 102, the second external electronic device 104, or the server 106) may execute the requested function or the added function and may transmit the executed result to the electronic device 100. The electronic device 100 may process the received result without change or additionally and may provide the requested function or service. For this purpose, for example, cloud computing technologies, distributed computing technologies, or client-server computing technologies may be used.

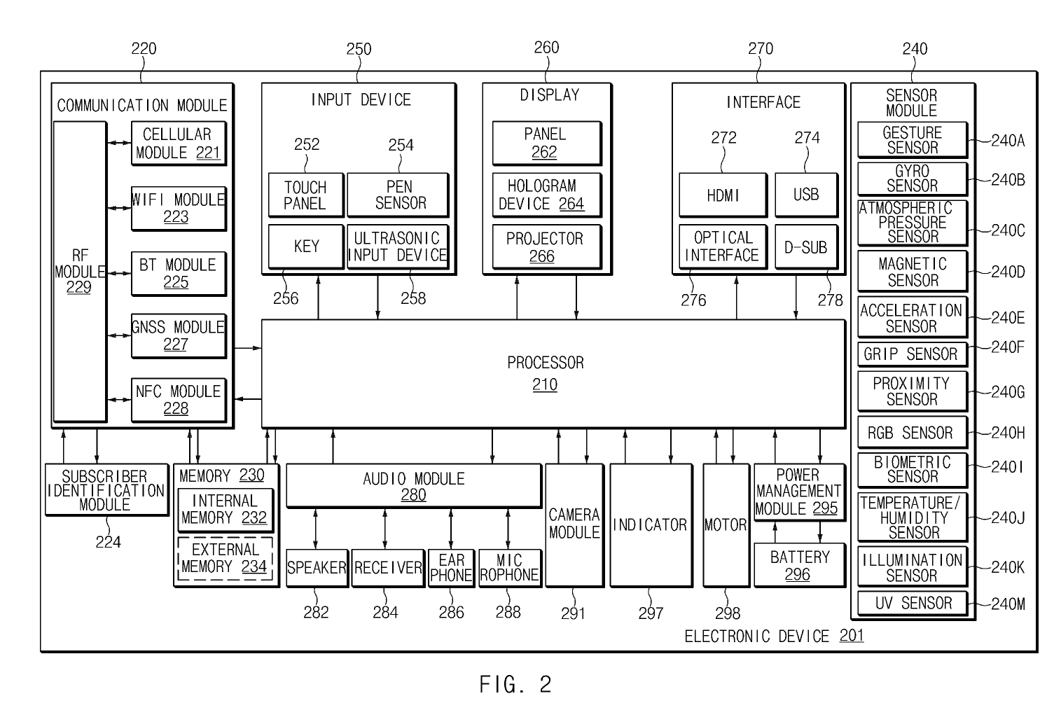

FIG. 2 illustrates a block diagram of a configuration of an electronic device 200 according to various embodiments. The electronic device 200 may include, for example, all or part of an electronic device 100 shown in FIG. 1. The electronic device 200 may include one or more processors 210 (e.g., application processors (APs)), a communication circuit 220, a subscriber identification module (SIM) 224, a memory 230, a sensor circuit 240, an input device 250, a display circuit 260, an interface 270, an audio circuit 280, a camera module 291, a power management module 295, a battery 296, an indicator 297, and a motor 298.

The processor 210 may drive, for example, an operating system (OS) or an application program to control a plurality of hardware or software components connected thereto and may process and compute a variety of data. The processor 210 may be implemented with, for example, a system on chip (SoC). According to an embodiment, the processor 210 may include a graphic processing unit (GPU) (not shown) and/or an image signal processor (not shown). The processor 210 may include at least some (e.g., a cellular module 221) of the components shown in FIG. 2. The processor 210 may load instructions or data received from at least one of other components (e.g., a non-volatile memory) into a volatile memory to process the data and may store various data in a non-volatile memory.

The communication circuit 220 may have the same or similar configuration to a communication circuit 170 of FIG. 1. The communication circuit 220 may include, for example, the cellular module 221, a wireless-fidelity (Wi-Fi) module 223, a Bluetooth (BT) module 225, a global navigation satellite system (GNSS) module 227 (e.g., a GPS module, a Glonass module, a Beidou module, or a Galileo module), a near field communication (NFC) module 228, and a radio frequency (RF) module 229.

The cellular module 221 may provide, for example, a voice call service, a video call service, a text message service, or an Internet service, and the like through a communication network. According to an embodiment, the cellular module 221 may identify and authenticate the electronic device 200 in a communication network using a SIM 224 (e.g., a SIM card). According to an embodiment, the cellular module 221 may perform at least part of functions which may be provided by the processor 210. According to an embodiment, the cellular module 221 may include a communication processor (CP).

The Wi-Fi module 223, the BT module 225, the GNSS module 227, or the NFC module 228 may include, for example, a processor for processing data transmitted and received through the corresponding module. According to various embodiments, at least some (e.g., two or more) of the cellular module 221, the Wi-Fi module 223, the BT module 225, the GNSS module 227, or the NFC module 228 may be included in one integrated chip (IC) or one IC package.

The RF module 229 may transmit and receive, for example, a communication signal (e.g., an RF signal). Though not shown, the RF module 229 may include, for example, a transceiver, a power amplifier module (PAM), a frequency filter, or a low noise amplifier (LNA), or an antenna, and the like. According to another embodiment, at least one of the cellular module 221, the Wi-Fi module 223, the BT module 225, the GNSS module 227, or the NFC module 228 may transmit and receive an RF signal through a separate RF module.

The SIM 224 may include, for example, a card which includes a SIM and/or an embedded SIM. The SIM 224 may include unique identification information (e.g., an integrated circuit card identifier (ICCID)) or subscriber information (e.g., an international mobile subscriber identity (IMSI)).

The memory 230 (e.g., a memory 130 of FIG. 1) may include, for example, an embedded memory 232 or an external memory 234. The embedded memory 232 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 234 may include a flash drive, for example, a compact flash (CF), a secure digital (SD), a micro-SD, a mini-SD, an extreme digital (xD), a multimedia car (MMC), or a memory stick, and the like. The external memory 234 may operatively and/or physically connect with the electronic device 200 through various interfaces.

The sensor circuit 240 may measure, for example, a physical quantity or may detect an operation state of the electronic device 200, and may convert the measured or detected information to an electric signal. The sensor circuit 240 may include at least one of, for example, a gesture sensor 240A, a gyro sensor 240B, a barometric pressure sensor 240C, a magnetic sensor 240D, an acceleration sensor 240E, a grip sensor 240F, a proximity sensor 240G, a color sensor 240H (e.g., red, green, blue (RGB) sensor), a biometric sensor 240I, a temperature/humidity sensor 240J, an illumination sensor 240K, or an ultraviolet (UV) sensor 240M. Additionally or alternatively, the sensor circuit 240 may include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor circuit 240 may further include a control circuit for controlling at least one or more sensors included therein. In various embodiments, the electronic device 200 may further include a processor configured to control the sensor circuit 240, as part of the processor 210 or to be independent of the processor 210. While the processor 210 is in a sleep state, the electronic device 200 may control the sensor circuit 240.

The input device 250 may include, for example, a touch panel 252, a (digital) pen sensor 254, a key 256, or an ultrasonic input unit 258. The touch panel 252 may use at least one of, for example, a capacitive type, a resistive type, an infrared type, or an ultrasonic type. Also, the touch panel 252 may include a control circuit. The touch panel 252 may further include a tactile layer and may provide a tactile reaction to a user.

The (digital) pen sensor 254 may be, for example, part of the touch panel 252 or may include a separate sheet for recognition. The key 256 may include, for example, a physical button, an optical key, or a keypad. The ultrasonic input unit 258 may allow the electronic device 201 to detect a sound wave using a microphone (e.g., a microphone 288) and to verify data through an input tool generating an ultrasonic signal.

The display circuit 260 (e.g., a display circuit 160 of FIG. 1) may include a panel 262, a hologram device 264, or a projector 266. The panel 262 may include the same or similar configuration to the display circuit 160 of FIG. 1. The panel 262 may be implemented to be, for example, flexible, transparent, or wearable. The panel 262 and the touch panel 252 may be integrated into one module. The hologram device 264 may show a stereoscopic image in a space using interference of light. The projector 266 may project light onto a screen to display an image. The screen may be positioned, for example, inside or outside the electronic device 200. According to an embodiment, the display circuit 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature 278. The interface 270 may be included in, for example, a communication circuit 170 shown in FIG. 1. Additionally or alternatively, the interface 270 may include, for example, a mobile high definition link (MHL) interface, an SD card/multimedia card (MMC) interface, or an infrared data association (IrDA) standard interface.

The audio circuit 280 may interchangeably convert a sound and an electric signal. At least part of components of the audio circuit 280 may be included in, for example, an I/O interface 150 shown in FIG. 1. The audio circuit 280 may process sound information input or output through, for example, a speaker 282, a receiver 284, an earphone 286, or the microphone 288, and the like.

The camera module 291 may be a device which captures a still image and a moving image. According to an embodiment, the camera module 291 may include one or more image sensors (not shown) (e.g., a front sensor or a rear sensor), a lens (not shown), an image signal processor (ISP) (not shown), or a flash (not shown) (e.g., an LED or a xenon lamp).

The power management module 295 may manage, for example, power of the electronic device 200. According to an embodiment, though not shown, the power management module 295 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 296 and voltage, current, or temperature thereof while the battery 296 is charged. The battery 296 may include, for example, a rechargeable battery or a solar battery.

The indicator 297 may display a specific state of the electronic device 200 or part (e.g., the processor 210) thereof, for example, a booting state, a message state, or a charging state, and the like. The motor 298 may convert an electric signal into mechanical vibration and may generate vibration or a haptic effect, and the like. Though not shown, the electronic device 200 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo® standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

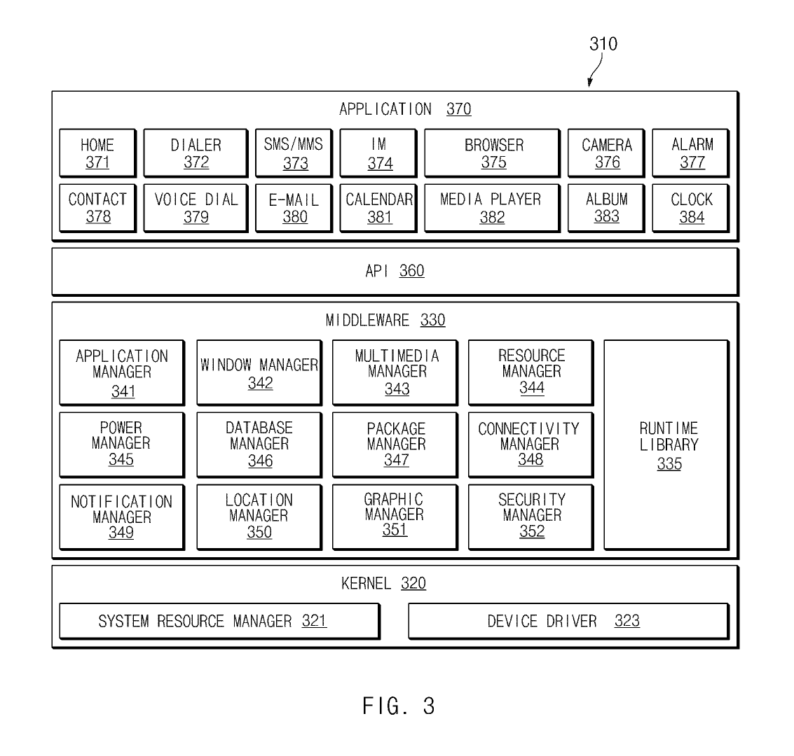

FIG. 3 illustrates a block diagram of a configuration of a program module according to various embodiments. According to an embodiment, a program module 310 (e.g., a program 140 of FIG. 1) may include an operating system (OS) for controlling resources associated with an electronic device (e.g., an electronic device 100 of FIG. 1) and/or various applications (e.g., an application program 147 of FIG. 1) which are executed on the OS. The OS may be, for example, Android®, iOS®, Windows®, Symbian®, Tizen®, or Bada®, and the like.

The program module 310 may include a kernel 320, a middleware 330, an application programming interface (API) 360, and/or at least one application 370. At least part of the program module 310 may be preloaded on the electronic device, or may be downloaded from an external electronic device (e.g., a first external electronic device 102, a second external electronic device 104, a server 106, and the like of FIG. 1).

The kernel 320 (e.g., a kernel 141 of FIG. 1) may include, for example, a system resource manager 321 and/or a device driver 323. The system resource manager 321 may control, assign, or collect, and the like system resources. According to an embodiment, the system resource manager 321 may include a process management unit, a memory management unit, or a file system management unit, and the like. The device driver 323 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 330 (e.g., a middleware 143 of FIG. 1) may provide, for example, functions the application 370 uses in common, and may provide various functions to the application 370 through the API 360 such that the application 370 efficiently uses limited system resources in the electronic device. According to an embodiment, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include, for example, a library module used by a compiler to add a new function through a programming language while the application 370 is executed. The runtime library 335 may perform a function about input and output management, memory management, or an arithmetic function.

The application manager 341 may manage, for example, a life cycle of at least one of the at least one application 370. The window manager 342 may manage graphic user interface (GUI) resources used on a screen of the electronic device. The multimedia manager 343 may ascertain a format necessary for reproducing various media files and may encode or decode a media file using a codec corresponding to the corresponding format. The resource manager 344 may manage source codes of at least one of the at least one application 370, and may manage resources of a memory or a storage space, and the like.

The power manager 345 may act together with, for example, a basic input/output system (BIOS) and the like, may manage a battery or a power source, and may provide power information necessary for an operation of the electronic device. The database manager 346 may generate, search, or change a database to be used in at least one of the at least one application 370. The package manager 347 may manage installation or update of an application distributed by a type of a package file.

The connectivity manager 348 may manage, for example, wireless connection such as Wi-Fi connection or BT connection, and the like. The notification manager 349 may display or notify events, such as an arrival message, an appointment, and proximity notification, by a method which is not disturbed to the user. The location manager 350 may manage location information of the electronic device. The graphic manager 351 may manage a graphic effect to be provided to the user or a user interface (UI) related to the graphic effect. The security manager 352 may provide all security functions necessary for system security or user authentication, and the like. According to an embodiment, when the electronic device (e.g., an electronic device 100 of FIG. 1) has a phone function, the middleware 330 may further include a telephony manager (not shown) for managing a voice or video communication function of the electronic device.

The middleware 330 may include a middleware module which configures combinations of various functions of the above-described components. The middleware 330 may provide a module which specializes according to kinds of OSs to provide a differentiated function. Also, the middleware 330 may dynamically delete some of old components or may add new components.

The API 360 (e.g., an API 145 of FIG. 1) may be, for example, a set of API programming functions, and may be provided with different components according to OSs. For example, with Android® or iOS®, one API set may be provided according to platforms. With Tizen®, two or more API sets may be provided according to platforms.

The application 370 (e.g., an application program 147 of FIG. 1) may include one or more of, for example, a home application 371, a dialer application 372, a short message service/multimedia message service (SMS/MMS) application 373, an instant message (IM) application 374, a browser application 375, a camera application 376, an alarm application 377, a contact application 378, a voice dial application 379, an e-mail application 380, a calendar application 381, a media player application 382, an album application 383, a clock application 384, a health care application (e.g., an application for measuring quantity of exercise or blood sugar, and the like), or an environment information application (e.g., an application for providing atmospheric pressure information, humidity information, or temperature information, and the like), and the like.

According to an embodiment, the application 370 may include an application (hereinafter, for better understanding and ease of description, referred to as “information exchange application”) for exchanging information between the electronic device (e.g., the electronic device 100) and an external electronic device (e.g., the first external electronic device 102 or the second external electronic device 104). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 102 or the second external electronic device 104). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first external electronic device 102 or the second external electronic device 104) which communicates with the electronic device, an application which operates in the external electronic device, or a service (e.g., a call service or a message service) provided from the external electronic device.

According to an embodiment, the application 370 may include an application (e.g., the health card application of a mobile medical device) which is preset according to attributes of the external electronic device (e.g., the first external electronic device 102 or the second external electronic device 104). According to an embodiment, the application 370 may include an application received from the external electronic device (e.g., the first external electronic devices 102, the second external electronic devices 104, or the server 106). According to an embodiment, the application 370 may include a preloaded application or a third party application which may be downloaded from a server. Names of the components of the program module 310 according to various embodiments of the present disclosure may differ according to kinds of OSs.

According to various embodiments, at least part of the program module 310 may be implemented with software, firmware, hardware, or at least two or more combinations thereof. At least part of the program module 310 may be implemented (e.g., executed) by, for example, a processor (e.g., a processor 210 of FIG. 2). At least part of the program module 310 may include, for example, a module, a program, a routine, sets of instructions, or a process, and the like for performing one or more functions.

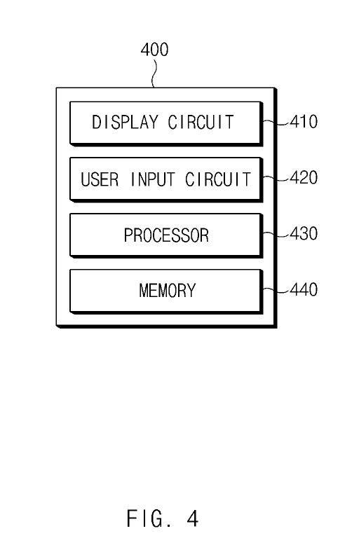

FIG. 4 illustrates a block diagram of a configuration of an electronic device 400 for providing a one-handed UI according to various embodiments of the present disclosure. Referring to FIG. 4, the electronic device 400 may include a display circuit 410, a user input circuit 420, a processor 430, and a memory 440. The configuration of the electronic device 400 is only one implementation example of the present disclosure, and several modifications are possible. For example, the electronic device 400 may further include a user interface (UI) for receiving any instructions or information from its user. In this example, the UI may generally be an input device such as a keyboard and a mouse. Alternatively, the UI may be a graphical user interface (GUI) displayed on a screen (not shown) of the electronic device 400.

The display circuit 410 may display a variety of content (e.g., an application execution screen, text, an image, a video, an icon, or a symbol, and the like) on an screen of the electronic device 400. The screen may include, for example, a liquid crystal display (LCD), a light emitting diode (LED) display, an organic LED (OLED) display, a microelectromechanical systems (MEMS) display, or an electronic paper display, and the like.

The user input circuit 420 may process a user input received from the user. The user input may be a touch input using a finger or a stylus (e.g., an electronic pen) of the user. Also, the user input may include a non-contact input, for example, a hover input, which may be provided through an electric change, although the finger or stylus of the user is not in direct contact with the screen. According to various embodiments of the present disclosure, the user input circuit 420 may be a touch integrated circuit (IC).

In this example, the user input circuit 420 (e.g., a touch circuit IC) may distinguish various types of touch inputs to process the touch inputs. The user inputs may include, for example, touch-down, touch drag (or touch move), touch release, touch hold (or long press), and touch and drop, and the like.

According to various embodiments of the present disclosure, although not illustrated in FIG. 4, the user input circuit 420 may receive a user input using various sensors (e.g., at least one or more sensors included in a sensor circuit 240 of FIG. 2) included in the electronic device 400. For example, the user input circuit 420 may receive a touch input of the user, an electronic pen input, or a hover input using a touch sensor.

Also, the user input may include a direction change of the electronic device 400. The electronic device 400 may determine whether its direction is changed using a gyro sensor and the like. The processor 430 may activate a transverse mode or a longitudinal mode based on a direction change of the electronic device 400.

The processor 430 may be implemented with, for example, a system on chip (SoC) and may include one or more of a central processing unit (CPU), a graphic processing unit (GPU), an image signal processor, an application processor (AP), or a communication processor (CP). The processor 430 may load instructions or data, received from at least one of the other components (e.g., the display circuit 410, the user input circuit 420, and the at least one or more sensors), into the memory 440 to process the instructions and data and may store a variety of data in the memory 440.

The processor 430 may display at least one or more objects on a screen via the display circuit 410. The object may include a control object and a content icon. The control object may be an object provided for convenience of the user on a one-handed UI. For example, the user may select an application icon which is too distant to be touched with his or her hand which holds the electronic device 400 using the control object.

According to various embodiments of the present disclosure, a location where the control object is displayed may be determined in consideration of a holding location of the user who holds the electronic device 400. For example, the processor 430 may display the control object on a location with which a thumb of a holding hand is in natural contact, in a state where the user holds the electronic device 400. According to various embodiments of the present disclosure, the location with which the thumb of the user is in natural contact may be determined through a user setting and may be determined by analyzing touch input history of the user.

The content icon may include, for example, an application icon, a folder icon, a favorites icon, a shortcut icon, a widget icon, and the like.

The processor 430 may receive a series of user inputs including touch-down, touch drag, and touch release on the control object via the user input circuit 420.

The processor 430 may receive touch-down on the control object via the user input circuit 420. The touch-down may refer to a user input which is input by an operation where the user is in contact with the screen with his or her finger. The processor 430 may display a pointer (or pointer image, or pointer object) on the display circuit 410 in response to the input touch-down. The pointer is to select an object for providing an execution command, for example, may correspond to a mouse pointer of a personal computer (PC).

Also, the processor 430 may display a function object on the display circuit 410 in response to the input touch-down. The function object may correspond to a hardware button. The hardware button may include a touch button, a home button, a volume button, a power button, and the like which are located in a housing of the electronic device 400. Also, the function object may be implemented to execute an operation which may not be input while the user holds the electronic device 400 through the function object. For example, the function object may be an object which may perform an operation of unfolding a quick-panel.

According to various embodiments of the present disclosure, the processor 430 may reduce brightness of a screen displayed on the screen in response to the input touch-down.

The processor 430 may receive touch drag in a state where touch-down on the control object occurs, via the user input circuit 420. The touch drag may refer to, for example, a user input which is input by an operation where a finger of the user moves on the screen while the finger is in contact with the screen. In this example, the processor 430 may move the control object and the pointer via the display circuit 410. According to various embodiments of the present disclosure, a movement distance of the control object may be different from a movement distance of the pointer. For example, the movement distance of the pointer may be longer than that of the control object. This is because a distance where the control object may be moved with a hand holding the electronic device 400 is limited (e.g., because a touch enable distance is limited if an operation of touching a control object displayed on a display using a thumb of a holding hand after the user holds the electronic device 400 with his or her both hands or one hand), but the pointer should be able to move on the entire region of the screen based on motion of the control object. The processor 430 may determine a value, in which some multiples are applied to a movement distance of the control object, as a movement distance of the pointer.

The processor 430 may stop touch drag on the control object and may receive touch release via the user input circuit 420. The touch release may refer to, for example, a user input which is input by an operation where the user takes his or her finger off the screen. The processor 430 may execute an operation corresponding to a location of the pointer at a time of the touch release. For example, if the pointer is on an application icon, the processor 430 may execute an application corresponding to the pointer. If the pointer is on a folder icon, the processor 430 may unfold a corresponding folder and may display detailed items.

According to various embodiments of the present disclosure, if the pointer is on a region where a content icon is not displayed (e.g., a region where only a background screen is displayed between a content icon and a content icon), the processor 430 may not execute any operation. Also, if the pointer departs from a screen displayed on the screen at a time of touch release on the control object, the processor 430 may not execute any operation.

According to various embodiments of the present disclosure, the touch release on the object may be performed together with touch hold. The touch hold may refer to, for example, an operation of stopping for periods of time while the user is in contact with the screen with his or her finger. If touch release including the touch hold is received via the user input circuit 420, the processor 430 may execute an operation corresponding to a location of the pointer at a time of the touch hold on the object. For example, if the pointer is on a content icon, the processor 430 may activate a mode of moving a location of the content icon or deleting the content icon. If the pointer is located on a region where a content icon is not displayed (e.g., a region where only a background screen is displayed between a content icon and a content icon), the processor 430 may display a menu.

If the control object is adjacent to the function object through the touch drag, the processor 430 may activate the function object. For example, if touch release on the control object is received on a location of the control object, the activation of the function object may indicate that the function object is ready to execute. Also, the processor 430 may indicate that the processor 430 is ready to execute the function object, via an indicator (e.g., an indicator displayed on an indicator region displayed on an upper end of a display). For example, the processor 430 may display the function object to be larger in size than a previous display state or may turn on/off the function object.

According to various embodiments of the present disclosure, the processor 430 may not display the function object in a situation where touch-down on the control object is received. If the control object or the pointer is adjacent to a specified location (e.g., a location where the function object will be displayed) based on a touch drag input on the control object, the processor 430 may display the function object.

After the touch release, the processor 430 may display the control object again on a location before the user input. Herein, according to various embodiments of the present disclosure, if touch release on the control object is performed after the control object is moved to a vertical axis by a half or more of the screen, the processor 430 may change a location of the control object and may display the changed control object. The operation of changing the location of the control object and displaying the changed control object may be an operation of changing a left-handed mode and a right-handed mode. For example, after the control object is moved to a right region of the screen in a state where the control object is displayed on a left region of the screen, if touch release on the control object occurs, the processor 430 may change the left-handed mode to the right-handed mode. Alternatively, the right-handed mode may be changed to the left-handed mode.

According to various embodiments of the present disclosure, the processor 430 may vary a function object displayed based on the left-handed mode and the right-handed mode. For example, the processor 430 may display a function object, corresponding to a hardware button located at the right of the electronic device 400, on a left region of the electronic device 400 in the left-handed mode. Similarly, the processor 430 may display a function object, corresponding to a hardware button located at the left of the electronic device 400, on a right region of the electronic device 400 in the right-handed mode.

According to various embodiments of the present disclosure, the processor 430 may vary a location of the function object in a transverse mode and a longitudinal mode of the electronic device 400. Also, the processor 430 may determine a location of a control object and a location of a pointer in a different way based on each of the transverse mode and the longitudinal mode.

The memory 440 may store data, for example, instructions for operations performed in the processor 430. In this example, the data stored in the memory 440 may include data input and output between components included in the electronic device 400 and data input and output between the electronic device 400 and components outside the electronic device 400.

This memory 440 may include an embedded memory or an external memory. The embedded memory may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory may include a flash drive, for example, a compact flash (CF), a secure digital (SD), a micro-SD, a mini-SD, an extreme digital (xD), a multimedia car (MMC), or a memory stick, and the like. The external memory may operatively and/or physically connect with the electronic device 400 through various interfaces.

It should be well understood to those skilled in the art that each of the display circuit 410, the user input circuit 420, the processor 430, and the memory 440 may be implemented to be independent of the electronic device 400 or one or more thereof may be implemented to be integrated into one in the electronic device 400.

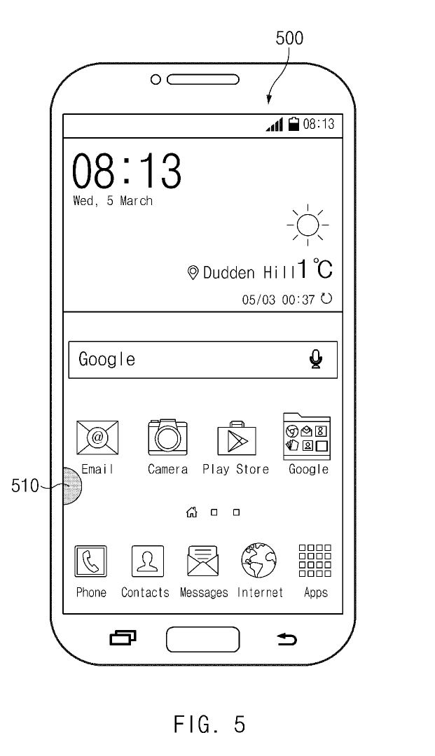

FIG. 5 illustrates a drawing of a basic state of a one-handed UI 500 according to various embodiments of the present disclosure.

Referring to FIG. 5, a control object 510 may be displayed on the one-handed UI 500. The basic state may refer to a state where any user input on the control object 510 is not received. A processor 430 of FIG. 4 may arrange the control object 510 at a left side of a screen of an electronic device 400 of FIG. 4 in response to executing the one-handed UI in a left-handed mode.

According to various embodiments of the present disclosure, the one-handed UI 500 may be activated after a user of the electronic device 400 selects a specified content icon or through a specified gesture of the user.

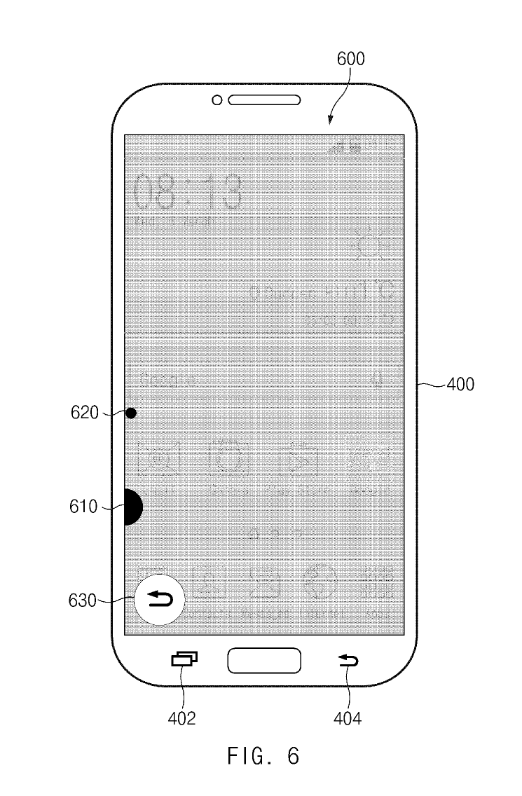

FIG. 6 illustrates a drawing of a one-handed UI 600 of a state where a touch-down user input on a control object 610 is received according to various embodiments of the present disclosure.

Referring to FIG. 6, the one-handed UI 600 may include the control object 610, a pointer 620, and a function object 630. The pointer 620 and the function object 630 may be displayed based on touch-down on the control object 610. The function object 630 may correspond to a hardware button 404 installed in a housing of an electronic device 400. A user of the electronic device 400 may select a hardware button 402 in a state where he or she holds the electronic device 400 with his or her left hand. However, the user may not select the hardware button 404 in a state where he or she holds the electronic device 400 with his or her left hand. Thus, the processor 430 may display the function object 630 corresponding to the hardware button 404 on a region where the control object 610 is located (e.g., a left region of a screen of the electronic device 400). Therefore, the electronic device 400 may allow the user to operate the electronic device 400 with his or her left hand in a state where he or she holds the electronic device 400 with his or her left hand.

Also, brightness of a screen displayed on the screen may be reduced based on touch-down on the control object 610. The reducing of the brightness may be shown in FIG. 6 by a shadow.

As described above, the function object 630 may be displayed based on the touch-down on the control object 610. However, embodiments of the present disclosure are not limited thereto. According to various embodiments of the present disclosure, the function object 630 may not be displayed and may then be displayed if the control object 610 is adjacent to the function object 630.

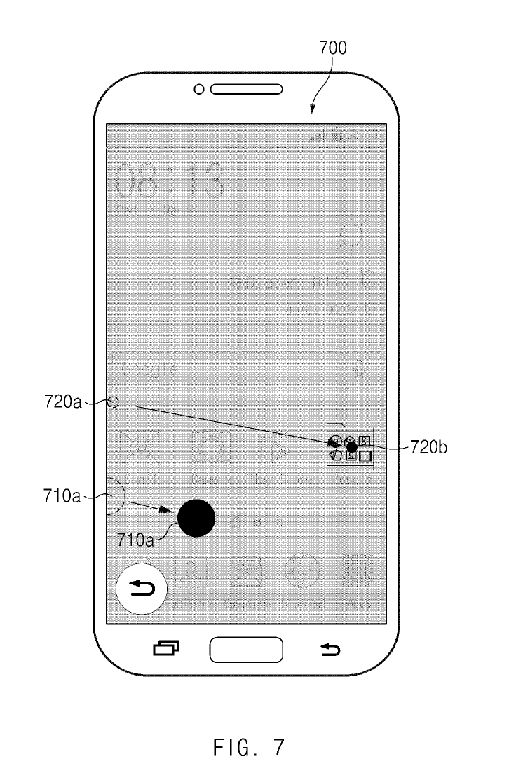

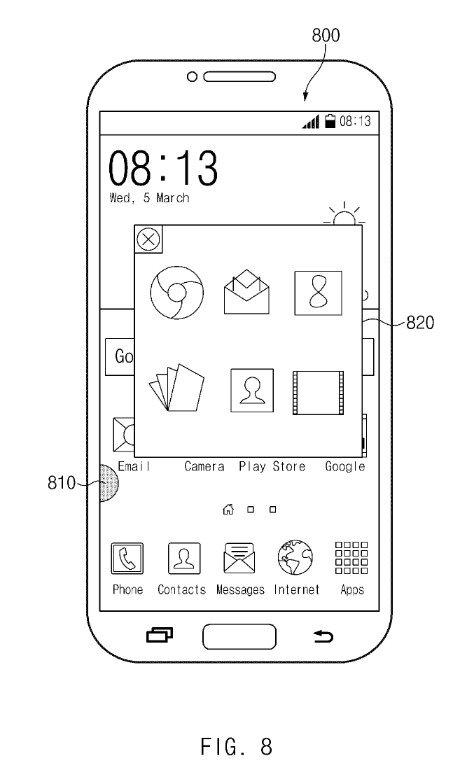

FIG. 7 illustrates a drawing of a one-handed UI 700 of a state where a touch drag user input on a control object is received according to various embodiments of the present disclosure. Also, FIG. 8 illustrates a drawing of a one-handed UI 800 of a state where a touch release user input on a control object 810 is received according to various embodiments of the present disclosure.

Referring to FIG. 7, a processor 430 of FIG. 4 may move the control object from a location 710a to a location 710b based on a touch drag user input. The processor 430 may move a pointer from a location 720a to a location 720b in response to the movement of the control object. The location 720b may be a region where a folder icon 730 is located. In this example, the processor 430 may receive a touch release user input on the control object and may perform an operation shown in FIG. 8 in response to the received touch release user input.

Referring to FIG. 8, the control object 810 and an execution screen 820 may be displayed on the on-handed UI 800. The folder execution screen 820 may correspond to a result of executing the folder icon 730 and may display a plurality of content icons included in the folder icon 730. If the pointer in FIG. 7 is located on an icon for an application, the processor 430 may execute the corresponding application.

Also, the control object 810 may correspond to the control object of FIG. 7 and may be displayed on an original location (e.g., a location where a control object 510 of FIG. 5 is displayed) together with executing the folder icon 730.

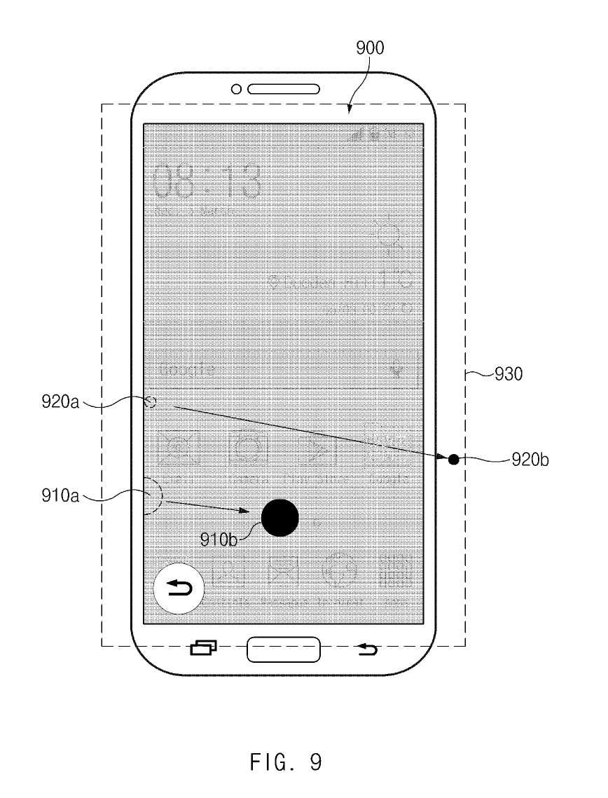

FIG. 9 illustrates a drawing of a one-handed UI 900 of a state where a touch drag user input on a control object is received according to various embodiments of the present disclosure.

Referring to FIG. 9, a processor 430 of FIG. 4 may move the control object from a location 910a to a location 910b based on a touch drag user input. The processor 430 may move a pointer from a location 920a to a location 920b in response to the movement of the control object. The location 920b may be a region which departs from a screen of an electronic device 400 of FIG. 4. In FIG. 9, the pointer is shown on the location 920b. However, this is for illustrative purposes of the present disclosure, and the processor 430 may not display the pointer which enters the region 930 any longer. In this example, if a touch release user input on the control object is received, the processor 430 may not execute any operation and may return to a basic state shown in FIG. 5. In other words, a user of the electronic device 400 may move the pointer to the region 930 on purpose to cancel a user input on the control object.

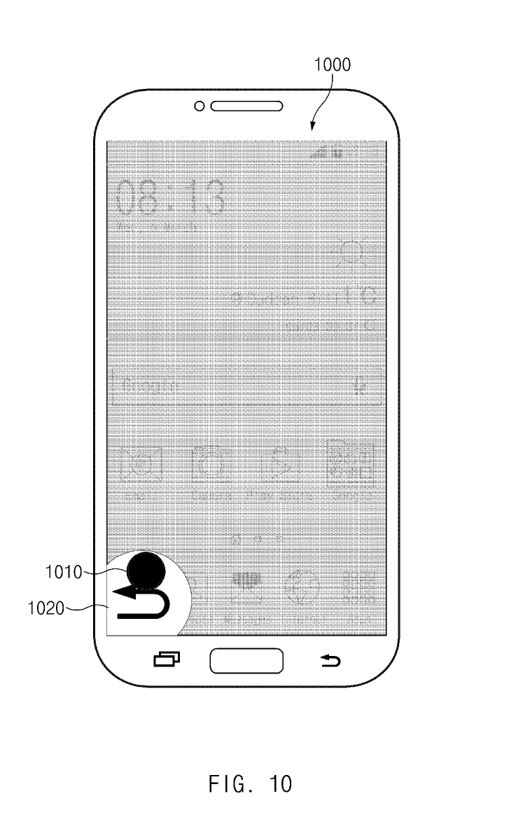

FIG. 10 illustrates a drawing of a one-handed UI 1000 of a state where a control object 1010 is adjacent to a function object according to various embodiments of the present disclosure.

Referring to FIG. 10, a processor 430 of FIG. 4 may move the control object 1010 to a location adjacent to the function object 1020 based on touch drag on the control object 1010. In this example, the processor 430 may activate the function object 1020 and may provide an activation indicator as an effect on the activation to a user of an electronic device 400 of FIG. 4. The activation indicator shown in FIG. 10 may be to increase the function object 1020 in size. In this example, the processor 430 may receive a touch release user input on the control object 1010 and may perform an operation corresponding to the function object 1020 in response to the received touch release user input.

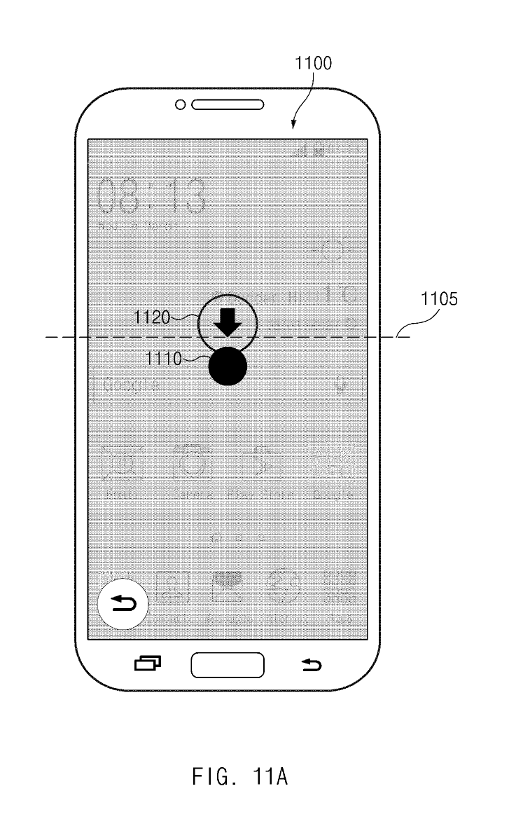

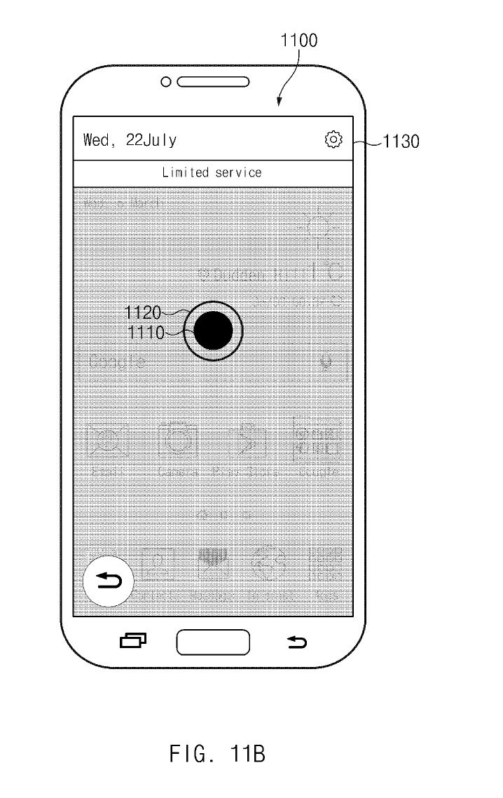

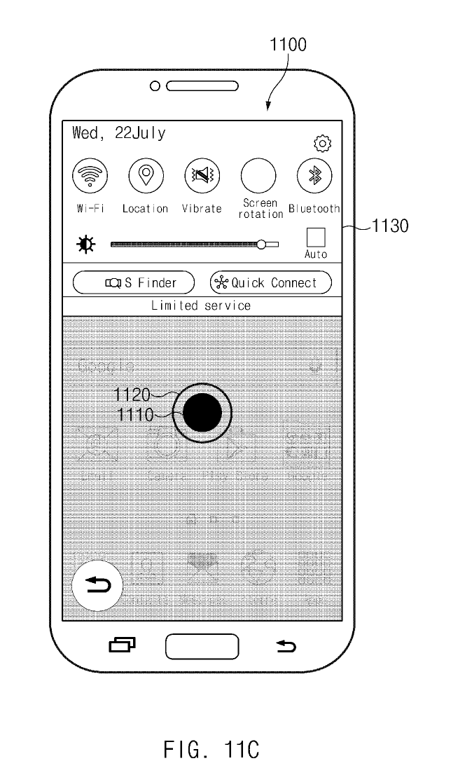

FIG. 11A illustrates a drawing of a one-handed UI 1100 of a state where a control object 1110 is adjacent to a function object 1120 according to various embodiments of the present disclosure.

Referring to FIG. 11A, a processor 430 of FIG. 4 may move the control object 1110 to a location adjacent to the function object 1120 based on touch drag on the control object 1110

The function object 1120 may be in a state where the function object 1120 is not displayed, before the control object 1110 is close to the function object 1120. For example, if the control object 1110 is adjacent to a specified location, for example, a dotted line 1105, the processor 430 may display the function object 1120. If the control object 1110 is close to the dotted line 1105, and the function object 1120 may be displayed while moving from an upper end of a screen of an electronic device 400 of FIG. 4 to a location shown in FIG. 11A.

A state immediately before the function object 1120 is displayed may be a state immediately after a pointer passes an upper end of the screen based on motion of the control object 1110, and the pointer may be in a state where the pointer is not displayed on the screen. If touch drag on the function object 1120 occurs upwardly in this state, the function object 1120 may be activated and downward motion to a location shown in FIG. 11A may be displayed.

In FIG. 11A, an embodiment of the present disclosure is exemplified as the function object 1120 is displayed on the center on a vertical axis of the screen. However, embodiments of the present disclosure are not limited thereto. For example, if touch drag on the control object 1110 occur to the left on the vertical axis of the screen, the function object 1120 may be displayed on a corresponding location (e.g., the left on the vertical axis of the screen). The function object 1120 may be an object which performs an operation of unfolding a quick-panel.

FIG. 11B illustrates a drawing of a one-handed UI 1100 of a state where a function object 1120 is activated based a location of a control object 1110 according to various embodiments of the present disclosure.

FIG. 11B, a processor 430 of FIG. 4 may combine the control object 1110 with the function object 1120 to display the combined control object 1110 and function object 1120. In this example, an activation indicator for the function object 1120 may be a magnetic effect. For example, the activation indicator may indicate an effect in which the control object 1110 adheres to the function object 1120 having different polarity by moving towards the function object 1120 by gravitation. In this example, part of a quick-panel 1130 may be displayed on an upper end of a screen of an electronic device 400 of FIG. 4.

FIG. 11C illustrates a drawing of a one-handed UI 1100 where an operation for a function object 1120 is executed according to various embodiments of the present disclosure.

FIG. 11C, a quick-panel 1130 may be fully displayed on the on-handed UI 1100. The operation of fully displaying the quick-panel 1130 may be performed through a touch drag user input of lowering a control object 1110 combined with the function object 1120. The operation may be implemented by implementing an operation of pulling down the quick-panel 1130 as an operation of lowering the function object 1120 through an intuitive UI shown in FIGS. 11B and 11C.

According to various embodiments of the present disclosure, after the control object 1110 is combined with the function object 1120 in FIG. 11B, a processor 430 of FIG. 4 may receive a touch release user input and may perform an operation of FIG. 11C. Alternatively, after the control object 1110 is combined with the function object 1120 in FIG. 11B, if receiving a touch release user input, the processor 430 may release selection for function object 1120. In this example, the quick-panel may disappear.

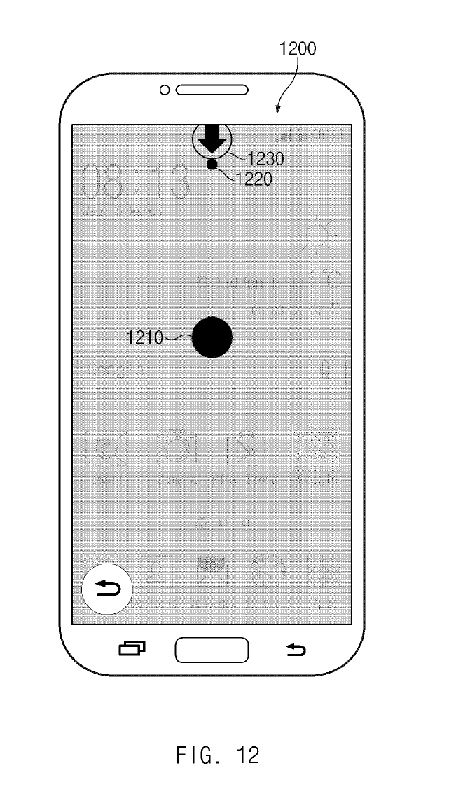

FIG. 12 illustrates a drawing of a one-handed UI 1220 of a state where a pointer 1220 is adjacent to a function object 1230 according to various embodiments of the present disclosure.

A processor 430 of FIG. 4 may receive a touch drag user input on a control object 1210 and may move the pointer 1220 in response to the touch drag user input. Referring to FIG. 12, if the pointer 1220 is adjacent to the function object 1230, the processor 430 may display the function object 1230.

In this example, the function object 1230 may be activated. Next, the processor 430 may receive a touch release user input on the control object 1210 or may receive a touch release user input of lowering the control object 1210, and may unfold a quick-panel.

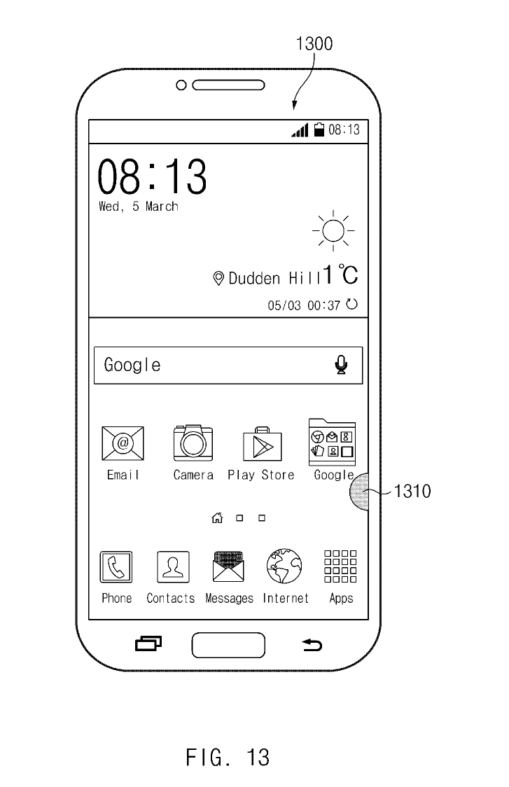

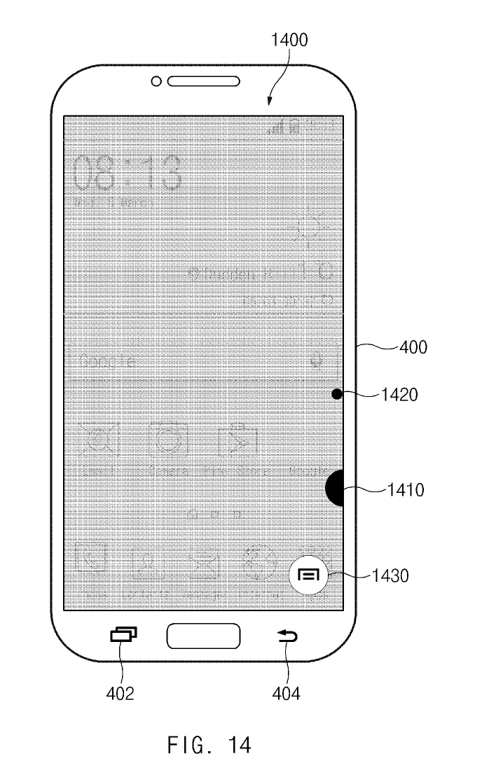

The one-handed UI which operates in the left-handed mode is described with reference to FIGS. 5 to 12. A one-handed UI which operates in a right-handed mode will be described below with reference to FIGS. 13 and 14.

FIG. 13 illustrates a drawing of a one-handed UI 1300 of a state where a right-handed mode and a left-handed mode are converted into each other according to various embodiments of the present disclosure. FIG. 14 illustrates a drawing of a one-handed UI 1400 of a state where a touch-down user input on a control object 1410 is received according to various embodiments of the present disclosure.

A control object 1310 of FIG. 13 may be located at the right of a screen of an electronic device 400 of FIG. 4 to be distinguished from a control object 510 of FIG. 5. In other words, a one-handed UI 500 of FIG. 5 operates in the left-handed mode, whereas the one-handed UI 1300 of FIG. 13 operates in the right-handed mode.

According to various embodiments of the present disclosure, the right-handed mode of FIG. 13 may be converted into the left-handed mode of FIG. 5. For example, if the control object 510 is located on a right region of the screen (e.g., a right half region of the screen) and then touch release on the control object 510 occurs through touch-down and touch drag on the control object 510, a processor 430 of FIG. 4 may convert the left-handed mode into the right-handed mode.

In FIG. 13, an embodiment of the present disclosure is exemplified as the control object 1310 of FIG. 13 is located at the same height as the control object 510 of FIG. 5. However, embodiments of the present disclosure are not limited thereto. According to various embodiments of the present disclosure, the control object 1310 of FIG. 13 may differ in height from the control object 510 of FIG. 5. The height of the control object 1310 in the right-handed mode may be determined based on a state where a user of the electronic device 400 holds the electronic device 400 with his or her right hand and may be determined to be independent of the left-handed mode.

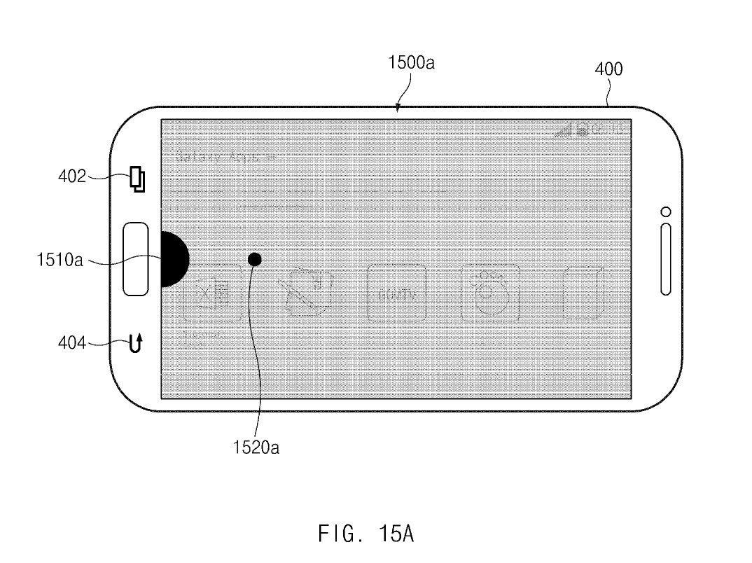

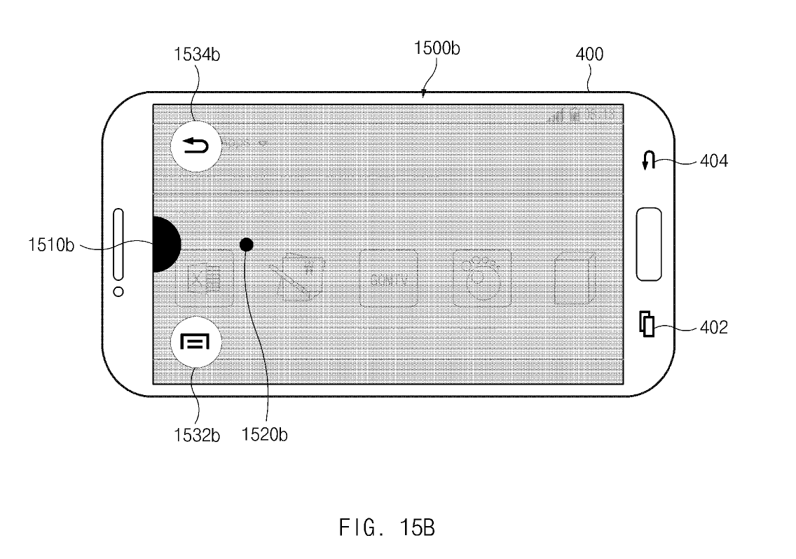

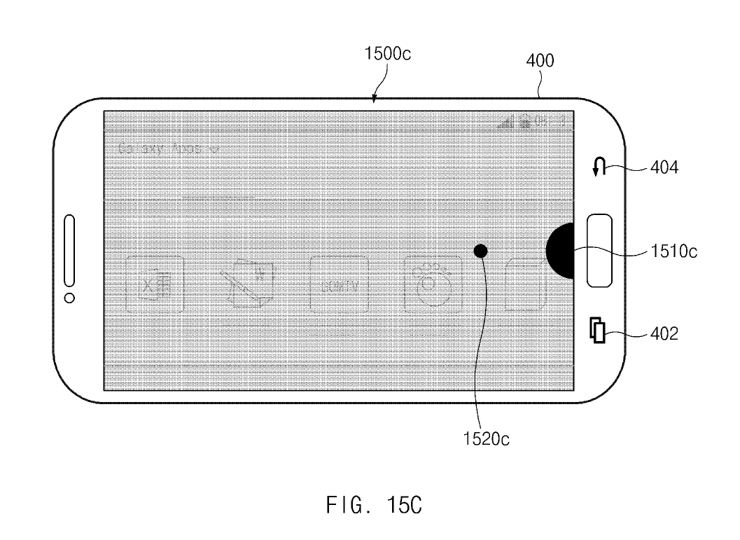

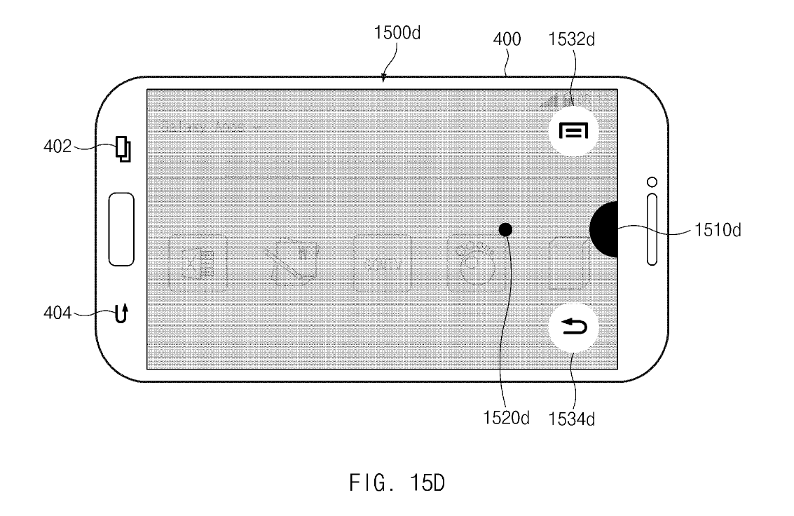

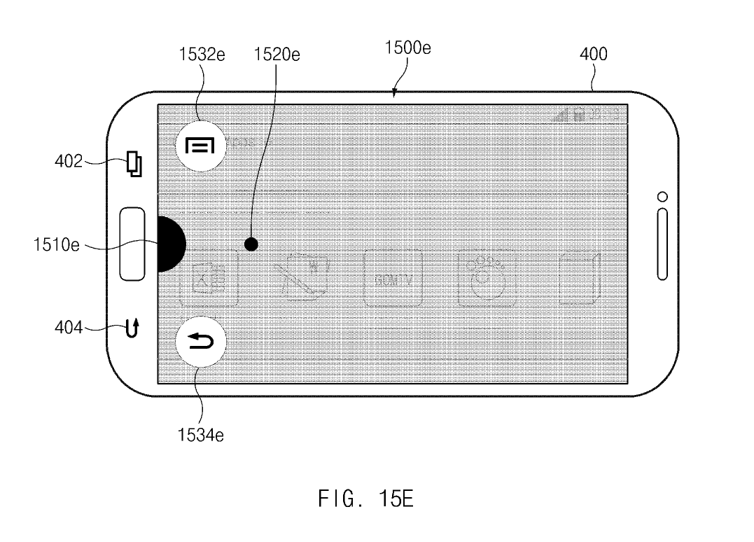

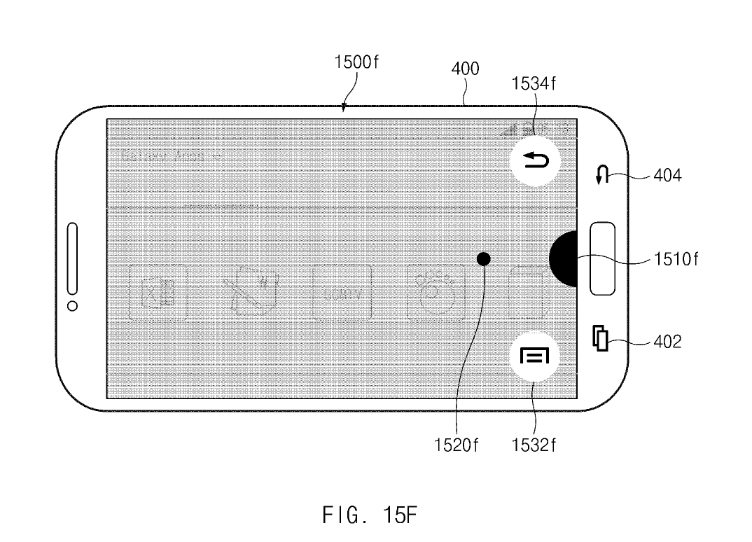

Referring to FIG. 14, the processor 430 may display a pointer 1420 and a function object 1430 on the one-handed UI 1400 based on a touch-down user input on the control object 1410. In this example, the function object 1430 of FIG. 14 may correspond to a hardware button 402 to be distinguished from a one-handed UI 600 of FIG. 6. The is because it is difficult for the user to select the hardware button 402 with his or her right hand while holding the electronic device 400 with his or her right hand. For this purpose, the processor 430 may output a control object corresponding to the hardware button 402 with reference to FIGS. 15A to 15F.

A longitudinal mode of the electronic device 400 is described with reference to FIGS. 5 to 14. Hereinafter, a description will be given of a transverse mode of the electronic device 400.

FIGS. 15A to 15F are drawings illustrating a one-handed UI 1500 for a transverse mode of an electronic device 400 according to various embodiments of the present disclosure.

FIGS. 15A and 15B illustrate drawings of one-handed UIs 1500a and 1500b which operate in a left-handed mode in the transverse mode of the electronic device 400. FIGS. 15C and 15D illustrate drawings of one-handed UIs 1500c and 1500d which operate in a right-handed mode in the transverse mode of the electronic device 400.

Referring to FIG. 15A, a control object 1510a and a pointer 1520a may be displayed on the one-handed UI 1500a. According to various embodiments of the present disclosure, a location of the control object 1510 in the transverse mode of the electronic device 400 may be determined in consideration of a state where a user of the electronic device 400 holds the electronic device 400.

Referring to FIG. 15B, a control object 1510b, a pointer 1520b, a first function object 1532b, and a second function object 1534b may be displayed on the one-handed UI 1500b. Compared with FIG. 15A, the user of FIG. 15A may select a first hardware button 402 or a second hardware button 440 in a state where he or she holds the electronic device 400 with his or her left hand. However, the user of FIG. 15B may not select the first hardware button 402 or the second hardware button 404 in the state where he or she holds the electronic device 400 with his or her left hand. Thus, the first function object 1532b and the second function object 1534b may be further displayed on the one-handed UI 1500b to be distinguished from the one-handed UI 1500a of FIG. 15A.

According to various embodiments of the present disclosure, the first function object 1532b and the second function object 1534b may be changed in location to each other.

Referring to FIG. 15C, a control object 1510c and a pointer 1520c may be displayed on the one-handed UI 1500c. According to various embodiments of the present disclosure, a location of the control object 1510 in the transverse mode of the electronic device 400 may be determined in consideration of a state where the user holds the electronic device 400.

Referring to FIG. 15D, a control object 1510d, a pointer 1520d, a first function object 1532d, and a second function object 1534d may be displayed on the one-handed UI 1500d. Compared with FIG. 15C, the user of FIG. 15C may select the first hardware button 402 or the second hardware button 404 in a state where he or she holds the electronic device 400 with his or her right hand. However, it may be difficult for the user of FIG. 15D to select the first hardware button 402 or the second hardware button 404 in the state where he or she holds the electronic device 400 with his or her right hand. Thus, the first function object 1532d and the second function object 1534d may be further displayed on the one-handed UI 1500d of FIG. 15D in connection with selecting a hardware button to be distinguished from the one-handed UI 1500c of FIG. 15C.

According to various embodiments of the present disclosure, the first function object 1532d and the second function object 1534d may be changed in location to each other.

Referring to FIG. 15E, a one-handed UI 1500e may be similar to the one-handed UI 1500a of FIG. 15A, but a first function object 1532e and a second function object 1534e may be displayed on the one-handed UI 1500e. In this example, the first hardware button 402 or the second hardware button 404 may be deactivated.

Similarly, referring to FIG. 15F, a one-handed UI 1500f may be similar to the one-handed UI 1500c of FIG. 15C, but a first function object 1532f and a second function object 1534f may be displayed on the one-handed UI 1500f. In this example, the first hardware button 402 or the second hardware button 404 may be deactivated.

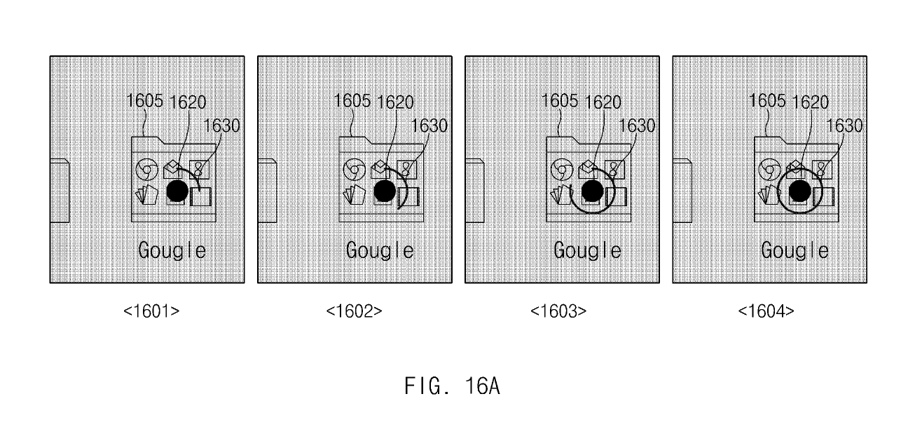

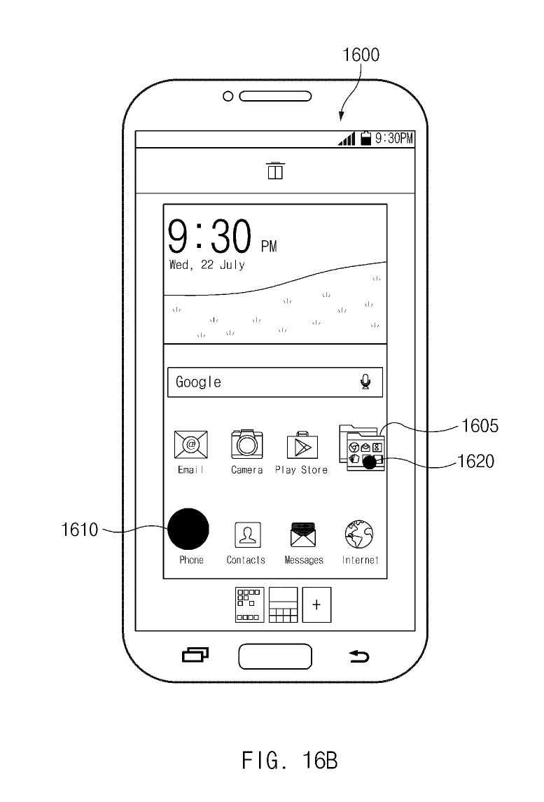

FIGS. 16A and 16B are drawings illustrating a one-handed UI 1600 of a state where a touch hold user input on a control object 1610 is received according to various embodiments of the present disclosure.

Referring to FIG. 16A, if receiving a touch hold user input on the control object 1610, a processor 430 of FIG. 4 may display an indicator for the touch hold user input.

According to various embodiments of the present disclosure, the indicator may be an operation where a gauge is filled around a pointer 1620.

Referring to operations “1601-1604” of FIG. 16A, an indicator 1630 may vary over a time when the touch hold user input continues. The operations “1601-1603” may indicate a state where it is insufficient to perform an operation corresponding to the touch hold user input. The operation “1604” may indicate a state where the operation corresponding to the touch hold user input may be performed.

The processor 430 may perform a long press operation on a folder icon 1605 where the pointer 1620 is located, based on a touch hold user input on the control object 1610. The operation is shown in FIG. 16B.

Referring to FIG. 16B, the processor 430 may activate a mode of moving a location of a content icon or deleting the content icon by the long press operation on the folder icon 1605.

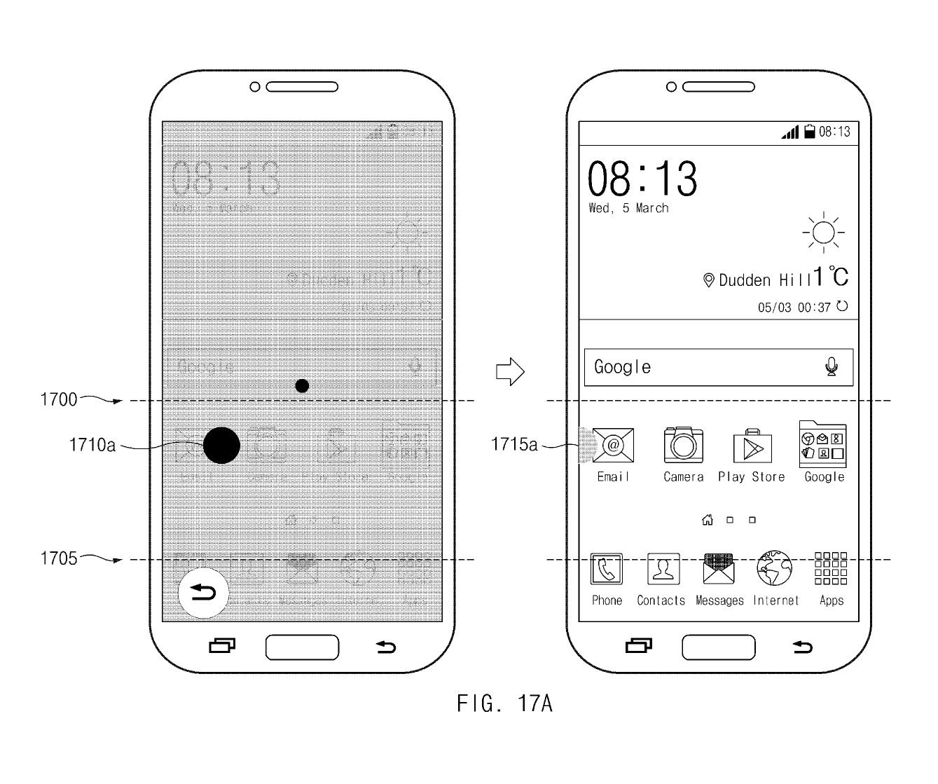

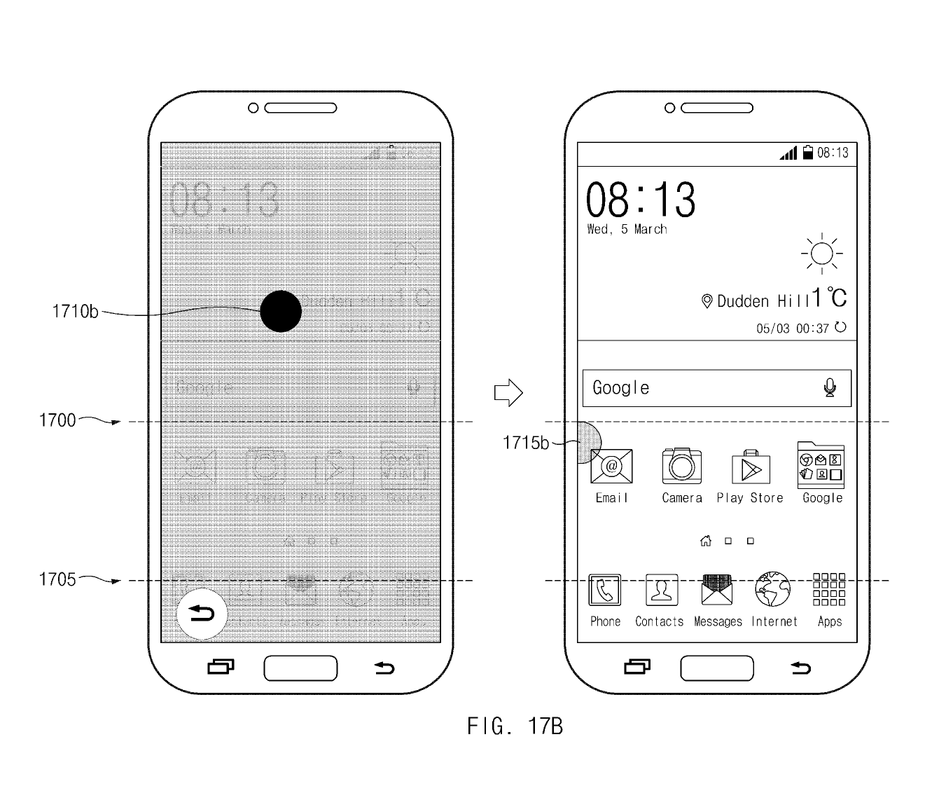

FIGS. 17A and 17B illustrate drawings of a location where a control object is displayed again upon touch release on a control object on a one-handed UI according to various embodiments of the present disclosure.

Referring to FIGS. 17A and 17B, the one-handed UI may include a first boundary line 1700 and a second boundary line 1705. The first boundary line 1700 and the second boundary line 1705 may be actually displayed on the one-handed UI, but may be shown for illustrative purposes.

A drawing shown in the left of FIG. 17A illustrates that the control object is released on a first location 1710a. A processor 430 of FIG. 1 may determine that a location where the control object is released is in the range of the first boundary line 1700 to the second boundary 1705. In this example, as shown in the right of FIG. 17A, the processor 430 may display the control object on a second location 1715a.

If comparing before and after the control object is released, the control object may have a released y coordinate without change and may have an x coordinate which is “0” (e.g., a specified start point).

Thus, a user of an electronic device 400 of FIG. 4 may move the control object in the range of the first boundary line 1700 to the second boundary line 1705. In this example, as described above, an x coordinate may be “0”.

A drawing shown in the left of FIG. 17B illustrates that the control object is released on a first location 1710b. The processor 430 may determine that a location where the control object is released departs from the range of the first boundary line 1700 to the second boundary line 1705. In this example, as shown in the right of FIG. 17B, the processor 430 may display the control object on a second location 1715b.

Comparing before and after the control object is released, a “y” coordinate of the control object may have a coordinate of the first boundary line 1700, and an “x” coordinate may be “0”.

If the location where the control object is released is lower than a “y” coordinate of the second boundary line 1705, a “y” coordinate of the control object, after the control object is released, may be a “y” coordinate of the second boundary line 1705.

Referring to FIGS. 17A and 17B, it may be seen that a location after the control object is released does not depart from the range of the first boundary line 1700 to the second boundary line 1705. Thus, the first boundary line 1700 and the second boundary line 1705 may be determined based on a level necessary for a one-handed operation.

According to an embodiments of the present disclosure, the present disclosure an electronic device including a display circuit configured to display a control object and a content icon spaced from the control object on a screen of the electronic device, a user input circuit configured to receive a user input and a processor configured to electrically connect with the display circuit and the user input circuit, wherein the processor is configured to execute content corresponding to the content icon in response to receiving a series of user inputs including touch-down, touch drag, and touch release associated with the control object.

According to various embodiments of the present disclosure, the processor is configured to display a pointer on a location based on the touch-down and move the displayed pointer based on the touch drag.

According to various embodiments of the present disclosure, the processor is configured to execute the content based on the touch release on the control object when the pointer is located on the content icon.

According to various embodiments of the present disclosure, the processor is configured to set a movement distance of the pointer to be longer than a movement distance of the control object and determine the movement distance of the pointer based on the movement distance of the control object.

According to various embodiments of the present disclosure, the processor is configured to after the touch release on the control object, display the control object on a location before the touch-down or display the control object within a range of a vertical axis upon the touch release and display the control object on a location having a horizontal axis before the touch-down.

According to various embodiments of the present disclosure, the control object after the touch release is displayed on a left side of the screen with respect to a vertical axis of the center of the electronic device, if the control object upon the touch release on the control object is located on a left region of the screen.

According to various embodiments of the present disclosure, the control object after the touch release is displayed on a right side of the screen with respect to a vertical axis of the center of the electronic device, if the control object upon the touch release on the control object is located on a right region of the screen.

According to various embodiments of the present disclosure, the processor is configured to display a function object in response to the touch-down on the control object.

According to various embodiments of the present disclosure, the processor is configured to map a function corresponding to the function object based on a user setting.

According to various embodiments of the present disclosure, the processor is configured to display an indicator for activating the function object if the control object is adjacent to a location where the function object is displayed by the touch drag.

According to various embodiments of the present disclosure, the processor is configured to perform an operation corresponding to executing the function object if the touch release on the control object is received on a location where the function object is displayed.

According to various embodiments of the present disclosure, the electronic device further may include a first hardware button and a second hardware button installed in a housing of the electronic device, and the processor is configured to map a function of the second hardware button to the function object, if a location where the function object is displayed corresponds to a location of the first hardware button and map a function of the first hardware button to the function object, if the location where the function object is displayed corresponds to a location of the second hardware button.

According to various embodiments of the present disclosure, the processor is configured to determine a location where the control object is displayed to be different from a location where the function object is displayed, based on a transverse mode or a longitudinal mode of the electronic device.

According to various embodiments of the present disclosure, the processor is configured to display a function object to correspond to a location of the control object if the control object is adjacent to a location by the touch drag.

According to various embodiments of the present disclosure, the function object is a quick-panel, and the processor is configured to operate the function object by the touch drag on the control object after the function object is displayed.

According to various embodiments of the present disclosure, the processor is configured to display an indicator indicating that touch hold is being received if the touch hold among user inputs on the function object is received.

According to various embodiments of the present disclosure, the processor is configured to determine a location where the control object is displayed in consideration of a location where a user of the electronic device holds the electronic device.

According to various embodiments of the present disclosure, the processor is configured to cancel the touch-down on the control object based on the touch release on the control object if the pointer departs from a region of the screen based on the touch drag.

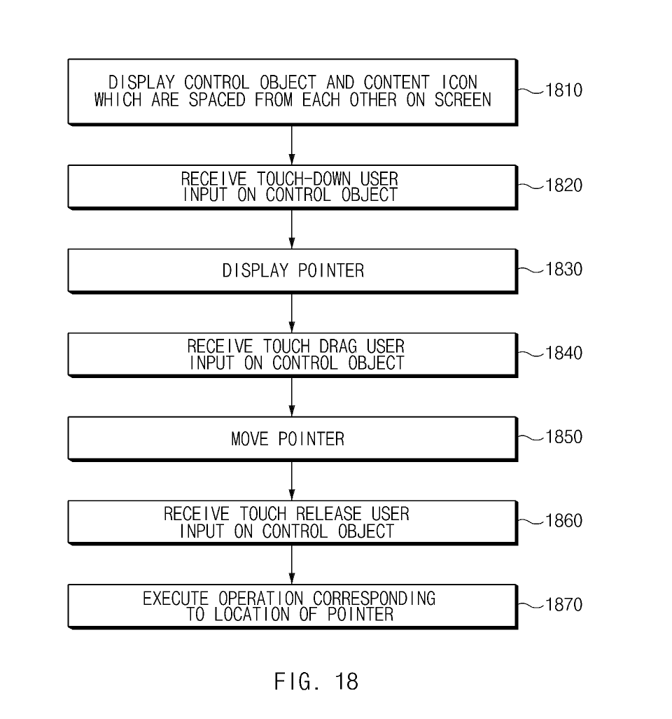

FIG. 18 illustrates a process performed on a one-handed UI according to various embodiments of the present disclosure. The operation performed on the one-handed UI shown in FIG. 18 may be performed in an electronic device 400 described with reference to FIGS. 1 to 16B. Thus, although there are contents which are not described in FIG. 18, the operation performed in the electronic device 400 described with reference to FIGS. 1 to 16B may be applied to the operation performed on the one-handed UI of FIG. 18.

In operation 1810, the electronic device 400 may display a control object and a content icon, which are spaced from each other, on its screen.

In operation 1820, the electronic device 400 may receive a touch-down user input on the control object displayed in operation 1810.

In operation 1830, the electronic device 400 may display a pointer based on the touch-down user input received in operation 1820.

In operation 1840, the electronic device 400 may perform an operation of receiving a touch drag user input on the control object, as a subsequent operation on the touch-down user input received in operation 1820.

In operation 1850, the electronic device 400 may move the pointer displayed in operation 1830 based on the touch drag user input received in operation 1840.

In operation 1860, the electronic device 400 may perform an operation of receiving a touch release user input on the control object, as a subsequent operation on the touch drag user input received in operation 1840.

In operation 1870, the electronic device 400 may execute an operation corresponding to the location of the pointer moved in operation 1850 based on the touch release user input received in operation 1860.

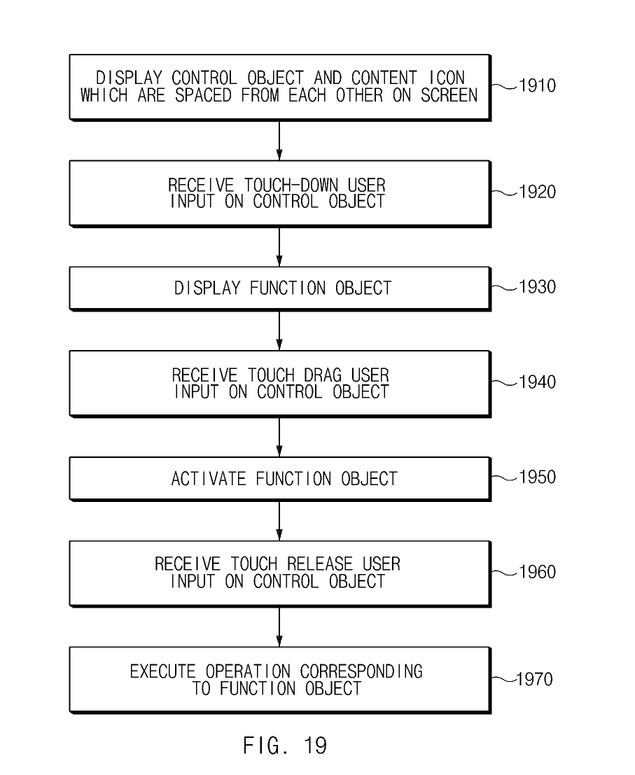

FIG. 19 illustrates a process performed in a one-handed UI according to various embodiments of the present disclosure. The operation performed on the one-handed UI shown in FIG. 19 may be performed in an electronic device 400 described with reference to FIGS. 1 to 16B. Thus, although there are contents which are not described in FIG. 19, the operation performed in the electronic device 400 described with reference to FIGS. 1 to 16B may be applied to the operation performed on the one-handed UI of FIG. 19.

In operation 1910, the electronic device 400 may display a control object and a content icon, which are spaced from each other, on its screen.

In operation 1920, the electronic device 400 may receive a touch-down user input on the control object displayed in operation 1910.

In operation 1930, the electronic device 400 may display a function object based on the touch-down user input received in operation 1920.

In operation 1940, the electronic device 400 may perform an operation of receiving a touch drag user input on the control object, as a subsequent operation on the touch-down user input received in operation 1920.

In operation 1950, the electronic device 400 may activate the function object displayed in operation 1930 based on the touch drag user input received in operation 1940.

In operation 1960, the electronic device 400 may perform an operation of receiving a touch release user input on the control object, as a subsequent operation on the touch drag user input received in operation 1940.

In operation 1970, the electronic device 400 may execute an operation corresponding to the function object activated in operation 1950 based on the touch release user input received in operation 1960.

According to an embodiment of the present disclosure, a method may include displaying a control object and a content icon spaced from the control object on a screen of the electronic device, receiving a series of user inputs including touch-down, touch drag, and touch release associated with the control object and executing content corresponding to the content icon in response to the received user inputs.

According to various embodiments, the method may further include displaying a pointer on a location based on the touch-down and moving the displayed pointer based on the touch drag.

According to an embodiment of the present disclosure, a computer-readable recording medium storing embodied thereon instructions is provided. When executed by at least one processor, the instructions may be configured to display a control object and a content icon spaced from the control object on a screen of an electronic device, receive a series of user inputs including touch-down, touch drag, and touch release associated with the control object and execute content corresponding to the content icon in response to the received user inputs.

According to various embodiments, the electronic device may execute an operation corresponding to a content icon which departs from a range by moving a control object displayed on its screen within the range which may operate with one hand of the user.

According to various embodiments, the electronic device may provide user convenience by distinguishing the left-handed mode from the right-handed mode. The electronic device may display the function object corresponding to the hardware button installed in the housing on the screen. For the left-handed mode, the electronic device may display the function object corresponding to the hardware button installed at the right of the electronic device on the left side of the electronic device. For the right-handed mode, the electronic device may display the function object corresponding to the hardware button installed at the left of the electronic device on the right side of the electronic device.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least part of a device (e.g., modules or the functions) or a method (e.g., operations) may be implemented with, for example, instructions stored in computer-readable storage media which have a program module. When the instructions are executed by a processor, one or more processors may perform functions corresponding to the instructions. The computer-readable storage media may be, for example, a memory.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory, and the like), and the like. Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included. Operations executed by modules, program modules, or other components may be executed by a successive method, a parallel method, a repeated method, or a heuristic method. Also, some operations may be executed in a different order or may be omitted, and other operations may be added.

Embodiments of the present disclosure described and shown in the drawings are provided as examples to describe technical content and help understanding but do not limit the present disclosure. Accordingly, it should be interpreted that besides the embodiments listed herein, all modifications or modified forms derived based on the technical ideas of the present disclosure are included in the present disclosure as defined in the claims, and their equivalents.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, such that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, and the like, that may store or receive software or computer code that when accessed and executed by the computer, processor or hardware implement the processing methods described herein.

The control unit may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, and the like. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device, comprising:
a display circuit configured to display a control object and a content icon spaced from the control object on a screen of the electronic device;
a user input circuit configured to receive a user input; and
a processor configured to electrically connect with the display circuit and the user input circuit,
wherein the processor is configured to execute content corresponding to the content icon in response to receiving a series of user inputs including touch-down, touch drag, and touch release associated with the control object.

2. The electronic device of claim 1, wherein the processor is configured to:
display a pointer on a location based on the touch-down; and
move the displayed pointer based on the touch drag.

3. The electronic device of claim 2, wherein the processor is configured to execute the content based on the touch release on the control object when at least part of the pointer is located on the content icon.

4. The electronic device of claim 2, wherein the processor is configured to:
set a movement distance of the pointer based on a movement distance of the control object; and
determine the movement distance of the pointer to be longer than the movement distance of the control object.

5. The electronic device of claim 1, wherein the processor is configured to:
display the control object, on a location before the touch-down, after the touch release on the control object; or
display the control object on a location within a range of a vertical axis upon the touch release and a location including a horizontal axis before the touch-down.

6. The electronic device of claim 1, wherein the control object, after the touch release, is displayed on a left side of the screen, with respect to a vertical axis of the center of the electronic device, if the control object, upon the touch release on the control object, is located on a left region of the screen, and
wherein the control object, after the touch release, is displayed on a right side of the screen, with respect to a vertical axis of the center of the electronic device, if the control object, upon the touch release on the control object, is located on a right region of the screen

7. The electronic device of claim 1, wherein the processor is configured to display a function object in response to the touch-down on the control object.

8. The electronic device of claim 7, wherein the processor is configured to map a function corresponding to the function object based on a user setting.

9. The electronic device of claim 8, wherein the processor is configured to display an indicator for activating the function object if the control object is adjacent to a location where the function object is displayed by the touch drag.

10. The electronic device of claim 8, wherein the processor is configured to execute an operation corresponding to the function object if the touch release on the control object is received on a location where the function object is displayed.

11. The electronic device of claim 8, further comprising:
a first hardware button and a second hardware button installed in a housing of the electronic device,
wherein the processor is configured to:
map a function of the second hardware button to the function object if a location where the function object is displayed corresponds to a location of the first hardware button; and
map a function of the first hardware button to the function object if the location where the function object is displayed corresponds to a location of the second hardware button.

12. The electronic device of claim 8, wherein the processor is configured to determine a location where the control object is displayed to be different from a location where the function object is displayed, based on a transverse mode or a longitudinal mode of the electronic device.

13. The electronic device of claim 1, wherein the processor is configured to display a function object to correspond to a location of the control object if the control object is adjacent to a location by the touch drag.

14. The electronic device of claim 13, wherein the function object is a quick-panel, and wherein the processor is configured to operate the function object by the touch drag on the control object after the function object is displayed.

15. The electronic device of claim 7, wherein the processor is configured to display an indicator indicating that touch hold is being received if the touch hold among user inputs on the function object is received.

16. The electronic device of claim 1, wherein the processor is configured to determine a location where the control object is displayed in consideration of a location where a user of the electronic device holds the electronic device.

17. The electronic device of claim 2, wherein the processor is configured to cancel the touch-down on the control object based on the touch release on the control object if the pointer departs from a region of the screen based on the touch drag.

18. A method performed in an electronic device, the method comprising:
displaying a control object and a content icon spaced from the control object on a screen of the electronic device;
receiving a series of user inputs including touch-down, touch drag, and touch release associated with the control object; and
executing content corresponding to the content icon in response to the received user inputs.

19. The method of claim 18, further comprising:
displaying a pointer on a location based on the touch-down; and
moving the displayed pointer based on the touch drag.

20. A computer-readable recording medium storing embodied thereon instructions, when executed by at least one processor, the instructions configured to:
display a control object and a content icon spaced from the control object on a screen of an electronic device;
receive a series of user inputs including touch-down, touch drag, and touch release associated with the control object; and
execute content corresponding to the content icon in response to the received user inputs.
